(19) United States
(12) Patent Application Publication
(10) Pub. No.: US 2023/0265905 A1
(43) Pub. Date: Aug. 24, 2023

(54) DEVICE FOR VOLUME COMPENSATION OF THE DAMPING LIQUID FOR A DAMPER

(71) Applicant: Motion, Villefranche-Sur-Saone (FR)

(72) Inventor: Matthieu Alfano, Fareins (FR)

(21) Appl. No.: 18/004,105

(22) PCT Filed: Jul. 5, 2021
(86) PCT No.: PCT/FR2021/051234

§ 371 Date: Jan. 3, 2023

(30) Foreign Application Priority Data
Jul. 3, 2020 (FR) FR2007055

(51) Int. Cl. F16F 9/34; F16F 9/06

(52) U.S. Cl. CPC F16F 9/3405; F16F 9/063; F16F 9/067; F16F 2230/06; F16F 2230/36

(57) ABSTRACT

A device for volume compensation of damping liquid for a damper includes a hollow cylindrical main body containing the damping fluid. A rod extends through an end of the main body to the interior thereof. The rod is secured to a piston inside the body, which divides a compression chamber from an expansion chamber. A compensation chamber is connected to the compression and expansion chambers via internal channels of the rod and piston. A plurality of orifices in the piston open into the compression chamber and into the expansion chamber. A rigid slider moves freely in translation through, around or inside the piston and/or the rod and closes and opens the orifices to connect the compensation chamber to the expansion chamber (or, respectively, the compression chamber) in the compression (or, respectively, expansion) phases. The device may be used in vehicle wheel suspension assemblies.

### CROSS-REFERENCE TO RELATED APPLICATIONS

This application is a national phase entry under 35 U.S.C. § 371 of International Patent Application PCT/FR2021/051234, filed Jul. 5, 2021, designating the United States of America and published as International Patent Publication WO 2022/003306 A1 on Jan. 6, 2022, which claims the benefit under Article 8 of the Patent Cooperation Treaty to French Patent Application Serial No. FR2007055, filed Jul. 3, 2020.

### TECHNICAL FIELD

The present disclosure relates to the field of dampers present in the suspensions of vehicles, and, in particular, cars, motorcycles, cycles and the like.

The present disclosure relates more particularly to a device that makes it possible to compensate the variation in the oil volume (or volume of other fluid used) inside a damper, whether this be due to the thermal expansion or to the displacement of the Rod of the Piston.

### BACKGROUND

In a simplified manner, a damper comprises at least one hollow cylindrical Main Body containing a damping fluid (for example, oil), at least one of the ends of which is provided with an axial passage for the passage, sealing and guiding of a Rod (the role of which is to transmit external forces), the Rod being secured to a Main Piston (the role of which is to transmit, to the Rod, forces resulting from internal load losses), which moves in translation inside the Body and divides it into two different working chambers, one constituting a Compression Chamber and the other constituting an Expansion Chamber. An Energy Dissipation Device (oil lamination) being present directly within the Main Piston or offset outside the Main Body and thus comprising an additional Hydraulic Circuit that allows for the circulation of the oil between the Compression and Expansion Chambers. During operation, the internal volume available for the oil varies significantly for two main reasons; on the one hand the thermal expansion of the oil, which is different from that of the material(s) of which the Body and other components of the damper are made up, and on the other hand the translation of the volume of the Rod, which is inside the Main Body, in part, during the compression phases, and then outside the body during the expansion phases.

In order to compensate for the variations in the volume of oil inside the damper, the current technologies comprise a Chamber referred to as the Compensation chamber. A Compensation Chamber is a compressible volume (for example, a cylinder comprising a gas) that is connected to the oil of the main circuit of the damper (i.e., the oil that is subjected to the pressure variations), comprising a separation device between the oil and the compressible or non-compressible element (for example, a Floating Piston or a membrane). The Compensation Chamber may have an initial zero or non-zero static pressure, or be referred to as “open” and thus have a pressure referred to as constant atmospheric pressure.

A first solution involves connecting the Compensation Chamber to the Compression Chamber (or, respectively, the Expansion Chamber). In this case, the Compensation Chamber must have a static pressure (initial pressure not due to the movement of the Piston) that is greater than the maximum dynamic pressure (pressure due to the Piston being set into motion) in the Compression Chamber (or, respectively, expansion chamber). Failing that, the displacement of the Piston will bring about the compression of the Compensation Chamber, and not the displacement of the oil through the Energy Dissipation Device, i.e., a “spring”-type behavior opposed to that sought, of the “damper” type. The increased static pressure, required for the operation of such a solution, brings about a restoring force of the Rod of the damper that can typically reach 300 N (example of a rear damper of a mountain bike), an increased threshold for movement of the joints (referred to as “sticking”), as well as increased risks of leaks. These phenomena will directly cause deterioration of the performance in terms of comfort (referred to as damper sensitivity), adhesion, and reliability.

A second solution involves connecting the Compensation Chamber after the Energy Dissipation Device. The pressure loss created by the device thus makes it possible to reduce the maximum dynamic pressure experienced by the Compensation Chamber, and to accordingly reduce the necessary static pressure thereof. The second solution does not entirely suppress the static pressure, but reduces it by approximately a factor of 3. This involves, however, the use of a remote Energy Dissipation Device.

Moreover, beyond the problem of an increased static pressure, the existing problems do not make it possible to immediately guarantee the compensation of the variation of the volume in the chamber referred to as negative. During compression (or, respectively, expansion), the pressure of the Compression Chamber (or, respectively, expansion chamber) increases; it is thus said to be “positive,” and the Expansion Chamber (or, respectively, compression chamber) is said to be “negative.” If the Compensation Chamber is not connected directly (i.e., with a low or negligible pressure loss) to the negative chamber, the volume compensation cannot be achieved sufficiently quickly, which causes a depression in the negative chamber (i.e., a pressure lower than the static pressure of the damper). The depression can create boiling and/or a vacuum, and bring about a cavitation phenomenon, damaging the functional components and deteriorating the performance.

Finally, these solutions do not allow for sufficient management of the vibrations retransmitted by the Rod. If the role of a damper is effectively that of damping the movements of the Rod (by dissipation of energy), it should ideally also allow for the filtration of vibrations thereof, i.e., not to re-transmit them to the Main Body (via the Energy Dissipation Device). In order to achieve this, the volume variations created by the vibrations should ideally be instantly and directly compensated by the Compensation Chamber. However, this is impossible in the configuration of the two solutions set out above, either on account of the too high static pressure of the Compensation Chamber (greater than the overpressure created by the vibrations), or on account of the position of the Compensation Chamber located “behind” the Energy Dissipation Device. The non-filtration of the vibrations entails a limitation of the comfort and adhesion performance, and brings about heating of the oil that deteriorates the operating reliability of the damper.

### BRIEF SUMMARY

The device according to the present disclosure makes it possible to directly (i.e., with a low or negligible pressure loss) connect (or, respectively, disconnect) the Compensation Chamber to the negative (or, respectively, positive) chamber, upon each change in the direction of movement of the Piston, i.e., each occasion of passage from a compression phase to an expansion phase and vice versa (the passage from one phase to the other is referred to as the transition phase). Thus, the Compensation Chamber is never subjected to a dynamic overpressure (present only in the positive chamber), and the static pressure thereof can be selected so as to be as low as desired, guaranteeing optimal functioning (comfort, adhesion and reliability) without a trigger threshold, without adhesive connection of the seal, and without a risk of leakage.

Moreover, the direct connection (low or negligible pressure loss) makes it possible to guarantee the minimum pressure of the negative chamber, which is thus equal to the static pressure of the Compensation Chamber, which reduces the risk of cavitation.

Finally, the device according to the present disclosure allows for the direct connection (i.e., having a low or negligible pressure loss) between the Compression Chamber, the Expansion Chamber and the Compensation Chamber during the phase changes (i.e., during a change in direction of the Piston). Thus, during the short transition phase, the oil is exchanged only among the three chambers, and in a manner having low or negligible pressure losses. In this use range, whether in compression or in expansion, and whatever the speed of passage from one phase to the other, these movements of the piston, referred to as low-amplitude oscillations, or vibrations, are thus filtered. There is thus neither dissipation of energy nor transmission of force to the Main Body. The performance in terms of comfort, adhesion and reliability (non-heating of the oil) is thus considerably increased.

In order to achieve this, the device according to the present disclosure comprises at least one hollow cylindrical Main Body containing a damping fluid (for example, oil), at least one of the ends of which is provided with an axial passage for the passage, sealing and guiding of a Rod, the Rod being secured to a Main Piston that moves in translation inside the body and divides it into two different working chambers, one constituting a Compression Chamber and the other constituting an Expansion Chamber. An Energy Dissipation Device (oil lamination) being present directly within the Main Piston or offset outside the Main Body and thus comprising a Hydraulic Circuit that allows for the circulation of the oil between the Compression and Expansion Chambers.

According to a first feature, the device comprises a Compensation Chamber that is connected directly (i.e., with a low or negligible pressure loss) to the Compression Chamber AND to the Expansion Chamber via one or more Internal Channels in the Rod and/or in the Piston, and thus one or more Orifices in the region of the Rod and/or the Piston that open into the Compression Chamber AND into the Expansion Chamber. These Orifices are referred to as compensation Orifices. According to an advantageous embodiment, the Compensation Chamber will thus be secured to the Rod, located opposite the Piston and outside of the main Body. However, the Compensation Chamber may be positioned anywhere and may make use of any type of connection according to the conventional practices that make it possible to implement the specific feature described above.

According to a second feature, the device comprises one or more rigid components referred to as Sliders (in the remainder of the description and in the interest of simplification, reference will be made to a “Slider,” whether this be single or multiple) that can move freely in translation through, around or inside the Piston and/or the Rod, in the axial direction of the Rod (and of the Main Body), and between two end positions, one toward the Compression Chamber, referred to as the “expansion position,” and the other toward the Expansion Chamber, referred to as the “compression position.” In its expansion position (or, respectively, compression position), the Slider shuts off (or actuates a device that shuts off) the Compensation Orifices of the Expansion Chamber (or of the compression chamber, respectively), and frees (or actuates a device that frees) the Compensation Orifices of the Compression Chamber (or, respectively, expansion chamber). Since the compensation Orifices and the Slider are positioned in such a way that it is impossible to simultaneously close both the compensation Orifices of the Compression Chamber and those of the Expansion Chamber, and that the sums of the free cross sections (i.e., those not shut off by the Slider) of these Orifices always allow for a direct passage of oil (i.e., having a low or negligible pressure loss). Since the Slider is a rigid component, the complete closure of the Compensation Orifices of the Compression Chamber (or, respectively, expansion chamber) necessarily and immediately brings about the opening of the Compensation Orifices of the Expansion Chamber (or, respectively, compression chamber). According to an advantageous embodiment, the Slider and the Piston and/or the Rod may be of a complementary shape that allows for the closure of the Orifices in a progressive manner, and that the Orifices are entirely shut off before any solid contact between the different parts.

Thus, since the Slider is freely translatable, when the damper begins a compression phase (or, respectively, expansion phase), the pressure increase (dynamic pressure) in the Compression Chamber (or, respectively, expansion chamber) creates a force that will move the Slider toward its compression position (or, respectively, expansion position), and thus close the Compensation Orifices of the Compression Chamber (or, respectively, expansion chamber) and open the Compensation Orifices of the Expansion Chamber (or, respectively, compression chamber). The Compensation Chamber will thus be directly connected to the Expansion Chamber (or, respectively, compression chamber), i.e., the chamber referred to as negative, but will not have any connection to the Compression Chamber (or, respectively, expansion chamber), i.e., the chamber referred to as positive.

According to a third feature, if another solution is implemented for the management of the variations in the oil volume, or the management is not necessary, and there is thus no Compensation Chamber directly connected to the Rod and/or the Main Piston, the piston comprises one or more channels allowing for the direct connection between the Compression Chamber and the Expansion Chamber, which makes it possible to ensure the vibration filtering function described above.

According to a particular embodiment, the Slider is in contact with the Main Body, in the radial direction. Thus, the friction existing between the Slider and the Body, however low this is, opposes the Slider being caused to move. When the Piston moves toward the Compression Chamber (or, respectively, expansion chamber), the Slider, which resists the movement, thus moves, relative to the Piston, toward the Expansion Chamber (or, respectively, compression chamber), even before the significant increase in the pressure in the Compression Chamber (or, respectively, expansion chamber). This phenomenon thus accelerates the Slider being brought into position, and accordingly reduces the duration of the transition phase.

According to a particular embodiment, the Slider is outside the Piston, i.e., it does not pass through it. Thus, the Piston cannot be in direct radial contact with the body; the Slider necessarily being present between the two parts. This embodiment results in the simplification of the Main Piston, while guaranteeing the particular embodiment above.

According to a particular embodiment, the Compensation Orifices are present only on the Piston. This embodiment results in a simplification of the Rod and the form of the Slider.

According to a particular embodiment, the Slider and the Piston are one. The “Piston/slider” is thus directly in translation on the Rod that comprises the compensation Orifices. This embodiment results in a reduction in the number of parts.

According to a particular embodiment, the Slider passes through the Piston in a non-discontinuous cross section (for example, cylindrical). This embodiment results in isolation of the Slider from transient forces between the Rod, the Piston and the body (radially), and in thus guaranteeing a translation of the device of optimized quality, and thus responsiveness.

According to a particular embodiment, the Slider closes an oil volume that reduces as the Slider approaches its end position. The shape of the Slider is such that the volume is closed before the “solid” interaction of the Slider with the Piston and/or the Rod, corresponding to its end position. The confinement of this volume creates a hydraulic stop. The oil volume is connected to a Hydraulic Circuit that is connected to the negative chamber and comprises a device of the non-return type (a valve, a ball/spring, a specific joint, etc.) that makes it possible to re-supply the oil volume during the phase change, and to displace the Slider again. This behavior, of the progressive hydraulic stop type, makes it possible to eliminate any risk of banging, noise or vibration associated with reaching end positions of the Slider; the operation of the device is softer and more silent.

The present disclosure thus relates, according to a first embodiment, to a device for volume compensation of the damping liquid for a damper, used for, in particular, suspension assemblies for cycles and other vehicles, which device comprises at least one hollow cylindrical Main Body containing a fluid, at least one of the ends of which is provided with an axial passage for the passage, sealing and guiding of a Rod, the Rod being secured to a Main Piston moving in translation inside the body and dividing it into two different working chambers, one constituting a Compression Chamber and the other constituting an Expansion Chamber, characterized in that the device comprises:
on the one hand a Compensation Chamber connected directly (i.e., with a small or negligible pressure loss) to the Compression Chamber and to the Expansion Chamber via one or more Internal Channels in the Rod and/or in the Piston, and thus one or more Orifices (referred to as Compensation Orifices) in the region of the Rod and/or of the Piston that open into the Compression Chamber and into the Expansion Chamber,
and on the other hand one or more rigid components referred to as the Slider that can move freely in translation through, around or inside the Piston and/or the Rod in the axial direction of the Rod (2) and of the Main Body, and between two end positions, one toward the Compensation Chamber, referred to as the “expansion position” (the other, respectively, toward the Expansion Chamber, referred to as the “compression position”) in which the Slider comes to shut off (or actuate a device that shuts off) the Compensation Orifices of the Expansion Chamber (5) (or, respectively, Compression Chamber), and frees (or actuates a device that frees) the Compensation Orifices of the Compression Chamber (or, respectively, the Expansion Chamber), the compensation Orifices and the Slider being positioned such that it is impossible to simultaneously close both the compensation Orifices of the Compression Chamber and those of the Expansion Chamber, and that the sum of the free cross sections (i.e., not shut off by the Slider) of the Orifices still allows for direct passage of oil (i.e., with a small or negligible pressure loss).

The present disclosure also relates, according to another embodiment, to a device for volume compensation of the damping liquid for a damper, used for, in particular, suspension assemblies for cycles and other vehicles, comprising at least one hollow cylindrical Main Body containing a fluid, at least one of the ends of which is provided with an axial passage for the passage, sealing and guiding of a Rod, the Rod being secured to a Main Piston moving in translation inside the body and dividing it into two different working chambers, one constituting a Compression Chamber and the other constituting an Expansion Chamber, characterized in that the device comprises:
on the one hand the Compensation Chamber and the Expansion Chamber are connected to one another directly (i.e., with a small or negligible pressure loss) or via one or more Internal Channels in the Rod and/or in the Piston, and thus one or more Orifices in the region of the Rod and/or the Piston that open into the Compression Chamber AND into the Expansion Chamber,
and on the other hand one or more rigid components referred to as the Slider that can move freely in translation through, around or inside the Piston and/or the Rod in the axial direction of the Rod and of the Main Body, and between two end positions, one toward the Compensation Chamber, referred to as the “expansion position” (the other, respectively, toward the Expansion Chamber, referred to as the “compression position”) in which the Slider comes to shut off (or actuate a device that shuts off) the Orifices of the Expansion Chamber (or, respectively, Compression chamber), and frees (or actuates a device that frees) the Orifices of the Compression Chamber (or, respectively, the Expansion chamber), the Orifices and the Slider being positioned such that it is impossible to simultaneously close both the compensation Orifices of the Compression Chamber and those of the Expansion Chamber, and that the sum of the free cross sections (i.e., not shut off by the Slider) of the Orifices still allows for direct passage of oil (i.e., with a small or negligible pressure loss).

According to other advantageous and non-limiting features of these two embodiments, taken in isolation or in any technically possible combination:
the Slider is in contact with the Main Body in the radial direction;
on the one hand the Slider is located in part between Piston and the Main Body, and on the other hand the Orifices are present only on the Piston;
the Slider and the Piston form just a single piece, i.e., the Piston/Slider moves in translation around the rod;
the Slider(s) pass(es) through the Piston in a non-discontinuous cross section (for example, cylindrical);
the slider closes an oil Volume on the compression side during a compression phase (or, respectively, the expansion side during an expansion phase) that reduces as the Slider approaches its end position, the shape of the Slider being such that the Volume becomes closed before the “solid” interaction of the Slider with the Piston and/or the Rod, the oil Volume being connected to the Expansion Chamber (or, respectively, Compression Chamber) via a Hydraulic Circuit that further comprises a device of the non-return type that allows for the movement of oil only from the Expansion Chamber (or, respectively, Compression Chamber) toward the Volume;
the slider and the Piston and/or the rod have a complementary shape that allows for the closure of the Orifices in a progressive manner, and in that the Orifices are entirely shut off before any solid contact between the different parts;
the Compensation Chamber is secured to the Rod and is located opposite the Piston and outside of the main Body; and
the slider is arranged so as to move freely in translation through a Passage formed in the region of the Piston, which passage is different from the Internal Channels.

The present disclosure also relates, according to another embodiment, to a device for volume compensation of a damping liquid for a damper, used for, in particular, suspension assemblies for cycles and other vehicles, comprising:
at least one hollow cylindrical Main Body containing a fluid and having at least one end provided with an axial passage for the passage, sealing and guiding of a Rod, the Rod being secured to a Main Piston moving in translation inside the main body and dividing it into two different working chambers, one constituting a Compression Chamber and the other constituting an Expansion Chamber, the Compression Chamber and the Expansion Chamber being directly connected to one another via one or more Internal Channels of the Piston for the passage of fluid through the Piston and one or more compensation Orifices in the region of the Piston that open into the Compression Chamber and into the Expansion Chamber, shutoff Valves for Compensation Orifices opening into the Compression Chamber and into the Expansion Chamber,
at least one rigid component that is interposed between the shutoff valves opening into the Compression Chamber and into the Expansion Chamber, the rigid component being able to move in translation in the axial direction of the Rod and of the Main Body, between a first end position in which the Compensation Orifices that open into the Expansion Chamber are shut off by the dedicated valve(s), while the Compensation Orifices that open into the Compression Chamber are not shut off by the dedicated valve(s), and a second end position, referred to as the compression position, in which the Compensation Orifices that open into the Compression Chamber are shut off by the dedicated valve(s), while the Compensation Orifices that open into the expansion Chamber are not closed by the dedicated valve(s), the compensation Orifices and the rigid component being positioned such that it is impossible to simultaneously close both the compensation Orifices that open into the Compression Chamber and the compensation Orifices that open into the Expansion Chamber, and such that the sum of the cross sections of the compensation Orifices that are not shut off by the actuating rigid component still allows for a direct passage of oil, and
the present disclosure being notable in that the rigid component is arranged so as to move freely in translation through a Passage formed in the region of the Piston, which passage is different from the Internal Channels.

According to other advantageous and non-limiting features of the present disclosure, taken in isolation or in any technically possible combination:
the shutoff Valves comprise two flexible plates fixed on either side of the Piston and secured thereto, the plates being capable of moving from a shut-off position in which the plates are arranged so as to be placed against the piston so as to shut off the compensation Orifices, to an open position in which they are moved apart from the piston under a thrust action of the rigid component, thus freeing the compensation orifices;
the rigid component comprises a pin moving in translation through a passage passing through the Piston;
the shutoff valves are arranged at the end of the piston, the shutoff valves and the rigid component form one piece;
the passage through which the rigid component moves in translation is formed between the piston and the piston body;
the rigid component is in contact with the Main Body in the radial direction;
the rigid component passes through the Piston in a non-discontinuous cross section (for example, cylindrical);
the rigid component closes an oil Volume on the compression side during a compression phase (or, respectively, the expansion side during an expansion phase) that reduces as the rigid component approaches its end position, the shape of the rigid component being such that the volume becomes closed before the “solid” interaction of the rigid component with the Piston, the oil Volume being connected to the Expansion Chamber (or, respectively, Compression Chamber) via a Hydraulic Circuit that further comprises a device of the non-return type that allows for the movement of oil only from the Expansion Chamber (or, respectively, Compression Chamber) toward the Volume;
the rigid component and the Piston have a complementary shape that allows for the closure of the Orifices in a progressive manner, and in that the Orifices are entirely shut off before any solid contact between the different parts;
the device comprises a Compensation Chamber that is connected directly (i.e., having a low or negligible pressure loss) to the Compression Chamber and to the Expansion Chamber;
the compensation chamber is connected to the Compression Chamber and to the Expansion Chamber via an axially internal channel of the Rod that is fluidically connected to the internal channel of the Piston; and
the Compensation Chamber is secured to the Rod and is located opposite the Piston and outside of the main Body.

### BRIEF DESCRIPTION OF THE DRAWINGS

The accompanying drawings illustrate the present disclosure:

FIGS. 1 and 2 are simplified schematic views, in longitudinal cross section, of a damper intended for locating the main elements and specifying the position of chambers, referred to as positive and negative, during compression (FIG. 1) and expansion (FIG. 2) phases;

FIG. 3 is a simplified schematic view, in longitudinal cross section, of the main elements of a damper equipped with an internal Compensation Chamber;

FIG. 4 is a simplified schematic view, in longitudinal cross section, of the main elements of a damper equipped with an external Compensation Chamber;

FIG. 5 is a simplified schematic view, in longitudinal cross section, of a first embodiment of the present disclosure;

FIGS. 6-9 are simplified schematic views, in longitudinal cross section, of the first embodiment of the slider, specifying the hydraulic paths taken by the fluid during the compression (FIG. 7), expansion (FIG. 9) and transitory (FIGS. 6 and 8) phases;

FIG. 10 is a simplified schematic view, in longitudinal cross section, of a variant of the present disclosure, with no variation in the volume of the Rod in the damper;

FIGS. 11 and 12 are simplified schematic views, in longitudinal cross section, of a second embodiment of the Slider, during compression (FIG. 11) and expansion (FIG. 12) phases;

FIG. 13 is a simplified schematic view, in longitudinal cross section, of a third embodiment of the Slider (in this case in position during an expansion phase);

FIGS. 14-17 are simplified schematic views, in longitudinal cross section, of a third embodiment of the Slider, during compression (FIG. 15), expansion (FIG. 17) and transitory (FIGS. 14 and 16) phases; and

FIGS. 18-21 are simplified perspective views of a Rod/Piston assembly according to a fourth embodiment, in a perspective view (FIG. 18) and in longitudinal cross section during compression (FIG. 19) and expansion (FIG. 20) phases.

For reasons of improved clarity, the identical or similar elements (i.e., those having the same function(s)) of the different figures are indicated by identical reference signs in all the figures.

### DETAILED DESCRIPTION

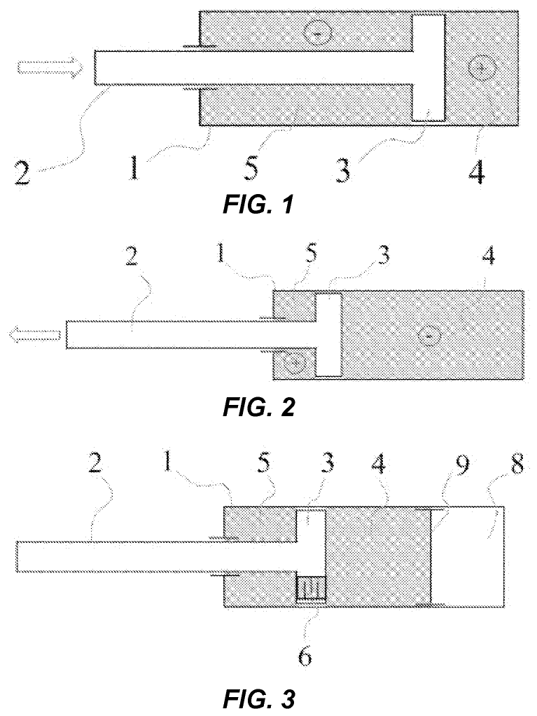

FIGS. 1-4 are two-dimensional schematic views showing dampers in simplified cross section, in order to define and name the various elements that are conventionally found in the dampers, and the roles of which have been set out above. Throughout the text, these elements are provided with a capital letter in order to denote that they are precisely defined. All these elements are referenced in the drawings.

For all the drawings, the double arrows represent the direction of movement of the Rod (2), and thus of the Piston (3) that is linked thereto.

For all the drawings, (−) denotes a depression, i.e., a pressure less than or equal to the static pressure of the damper. It is recalled that the static pressure of the damper is the initial pressure in the absence of movement of the Rod (2).

For all the drawings, (+) denotes an overpressure, i.e., a pressure greater than or equal to the static pressure of the damper.

FIGS. 1-4, as well as all the others, show the elements described above, such as the Main Body (1) that contains the damping fluid, the Rod (2), the role of which is to re-transmit the outside forces, the Piston or Main Piston (3), the role of which is to transmit, to the Rod, the forces resulting from internal pressure losses, the Compression Chamber (4), the pressure of which increases in the compression phase and reduces in the expansion phase, the Expansion Chamber (5), the pressure of which increases in the expansion phase and reduces in the compression phase, the Energy Dissipation Device (6), the Hydraulic Circuits (7), which allow for the circulation of the oil between the Compression and Expansion Chambers, the Compensation Chamber (8), which makes it possible to compensate the variations in the oil volume inside the damper, and the separation device between the oil and the compressible element of the Compensation Chamber, which is referred to as the Floating Piston (9), in the interest of simplification, even though other systems (membrane, etc.) exist.

FIG. 3 shows, in particular, a damper, the Compensation Chamber (8) of which is directly connected to the Compression Chamber. The disadvantages of such a solution have been explained above.

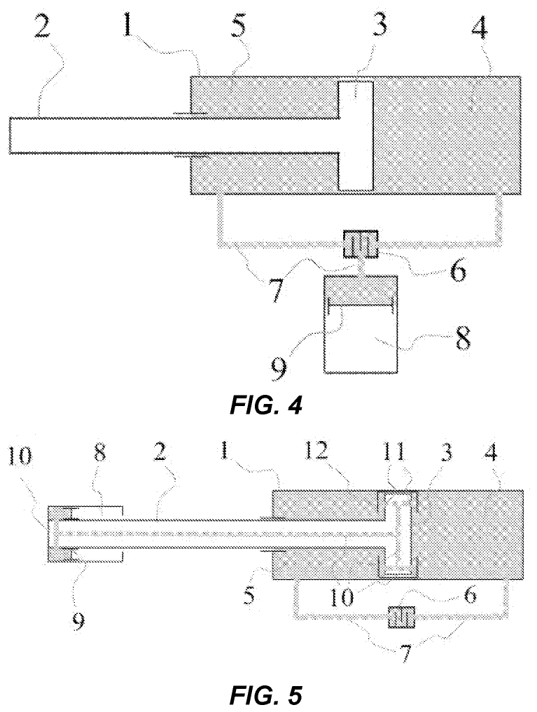

FIG. 4 shows, in particular, a damper, the Compensation Chamber (8) of which is connected “behind” the Energy Dissipation Device (6), and the advantages and limitations of which have been explained above.

FIG. 5 is a two-dimensional schematic view showing an embodiment of a damper that complies with all the requirements of the present disclosure.

In order to achieve this, the device according to the present disclosure comprises at least one hollow cylindrical Main Body (1) containing a damping fluid, at least one of the ends of which is provided with an axial passage for the passage, sealing and guiding of a Rod (2), the Rod being secured to a Main Piston (3) that moves in translation inside the Body (1) and divides it into two different working chambers, one constituting a Compression Chamber (4) and the other constituting an Expansion Chamber (5). An Energy Dissipation Device (6) being offset outside the Main Body (1) and thus comprising a Hydraulic Circuit (7) that allows for the circulation of the oil between the Compression and Expansion Chambers.

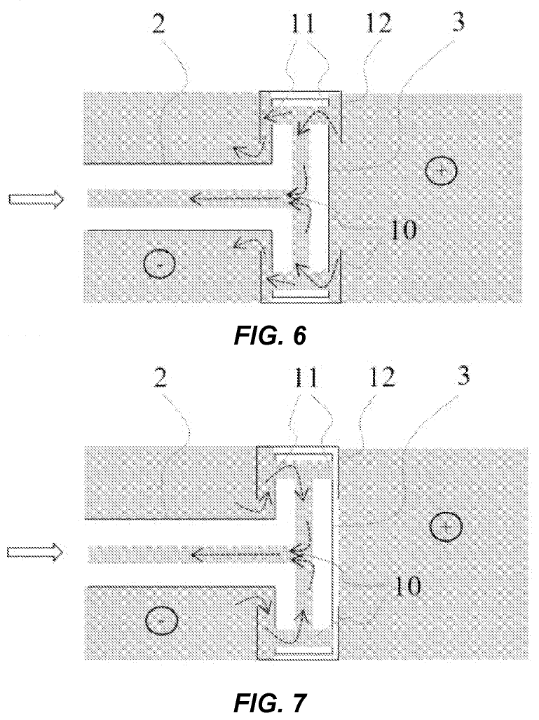

According to this embodiment, the device comprises a Compensation Chamber (8) that is connected directly to the Compression Chamber (4) AND to the Expansion Chamber (5) via Internal Channels (10) in the Rod (2) and/or in the Piston (3), and thus one or more Compensation Orifices (11) in the region of the Piston (3) that open into the Compression Chamber (4) AND into the Expansion Chamber (5). The Slider (12) is a first embodiment, the operation of which is set out in detail in FIGS. 6-9. In this case, the Slider (12) is a single piece that moves freely in translation around the Piston (3). In this embodiment, the Slider (12) is formed of a rigid component forming a sleeve arranged between the Main Body (1) and the Piston (3), the piece forming the sleeve having, at each end, a lower flange forming the shutoff Valves of the compensation orifices (11). In this embodiment, the shutoff Valves thus form a single piece with the rigid component forming the sleeve.

In FIGS. 6-9, the dotted arrows indicate the path and the displacement direction of the oil.

FIG. 6 corresponds to the start of a compression phase, i.e., the transitory compression phase. The Rod (2) moves toward the Compression Chamber (in this case to the right). The pressure of the Compression Chamber increases, which creates a displacement of oil from the Compression Chamber toward the Expansion Chamber, through the Compensation Orifices (11) and the Internal Channels (10). The oil thus does not pass through the Energy Dissipation Device (in this case external); there is no energy loss, no damping, and thus no reaction forces opposing the displacement of the rod (2). A filtration phenomenon thus occurs. During a compression phase, the Rod (2) enters the Main Body. The oil volume replaced by the volume of the entering Rod (2) thus has to leave the Main Body, because an “incompressible” fluid is present. The oil volume thus travels from the Compression Chamber toward the Compensation Chamber, via the Internal Channels (10), as is shown by the dotted arrows.

FIG. 7 corresponds to the “real” compression phase, i.e., following the shut-off of the Compensation Orifices (11) by the Slider (12) on the compression side. As the Compensation Orifices (11) are shut off, the oil cannot directly rejoin the Expansion Chamber, but is forced to move toward the external Energy Dissipation Device. Dissipation of energy thus occurs. A damping phenomenon thus occurs. On account of the presence of the Rod (2) in the expansion chamber, the movement of the Piston (3) toward the Compression Chamber displaces a volume of oil that is larger than the volume available in the Expansion Chamber. The excess oil then returns to the Compensation Chamber, via the Compensation Orifices (11), open on the expansion side, and the Internal Channels (10).

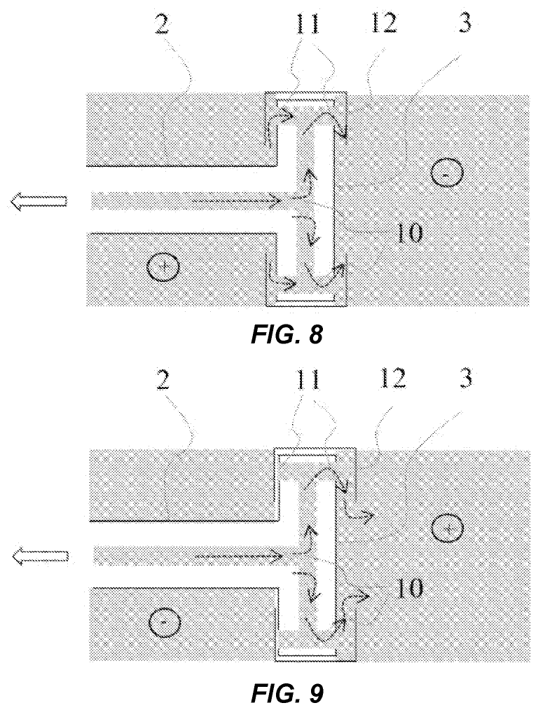

FIG. 8 corresponds to the start of an expansion phase, i.e., the transitory expansion phase. The Rod (2) moves toward the Expansion Chamber (in this case to the left). The pressure of the Expansion Chamber increases, which creates a displacement of oil from the Expansion Chamber toward the Compression Chamber, through the Compensation Orifices (11) and the Internal Channels (10). The oil thus does not pass through the Energy Dissipation Device; there is no energy loss, no damping, and thus no reaction forces opposing the displacement of the rod (2). A filtration phenomenon thus occurs. During an expansion phase, the Rod (2) leaves the Main Body. The volume of oil released by the volume of the exiting Rod (2) thus has to be compensated. The oil volume thus travels from the Compensation Chamber toward the Compression Chamber, via the Internal Channels (10), as is shown by the dotted arrows.

FIG. 9 corresponds to the “real” expansion phase, i.e., following the shut-off of the Compensation Orifices (11) by the Slider (12) on the expansion side. As the Compensation Orifices (11) are shut off, the oil cannot directly rejoin the Compression Chamber, but is forced to move toward the external Energy Dissipation Device. Dissipation of energy thus occurs. A damping phenomenon thus occurs. On account of the presence of the Rod (2) in the expansion chamber, the movement of the Piston (3) toward the Expansion Chamber displaces a volume of oil that is smaller than the volume available in the Compression chamber. The oil volume is thus compensated by the displacement of oil from the Compensation Chamber toward the Compression Chamber, via the Compensation Orifices (11), open on the compression side, and the Internal Channels (10).

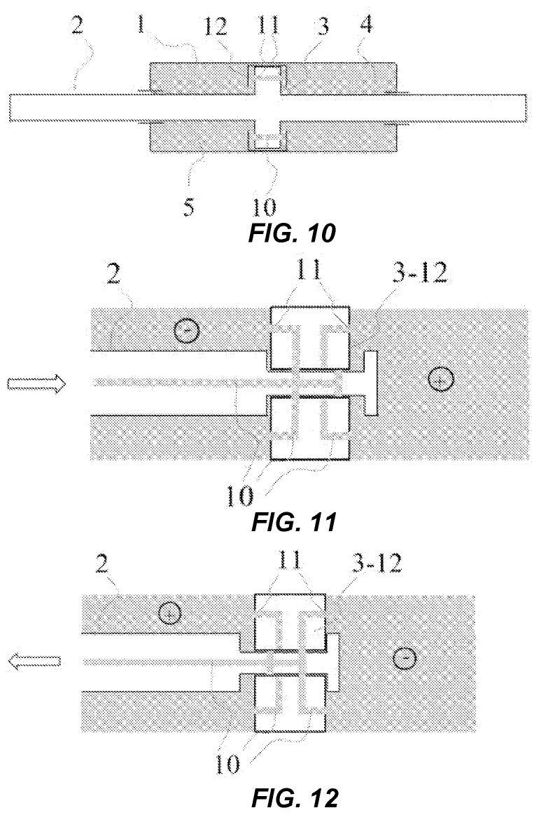

FIG. 10 shows an embodiment of the present disclosure, in the absence of a Compensation Chamber. In this example, the Rod (2) is “continuous.” Its movement thus does not cause any variation in the volume available for the oil. In this case, the present disclosure can be used for the single aim of achieving the filtration phenomenon explained above. In this case, the solution is achieved using the same type of Slider (12) as above. The advantage thereof is that it is simple in shape, and that, being in contact with the Body, by virtue of the friction this represents, it is naturally and quickly located in the correct position for allowing the shutoff and freeing of the Compensation Orifices (11).

FIGS. 11 and 12 show a second embodiment of the Slider (12). In this case, the Slider (12) and the Piston (3) form a single piece. The “Piston/slider” (3-12) is thus directly in translation on the Rod (2). This embodiment results in a reduction in the number of parts.

FIG. 11 shows this embodiment during a compression phase. It is noted here that the Compensation Chamber (not visible in the figure) is connected only to the Expansion Chamber (to the left), via the Internal Channels (10).

FIG. 12 shows this embodiment during an expansion phase. It is noted here that the Compensation Chamber (not visible in the figure) is connected only to the Compression Chamber (to the right), via the Internal Channels (10).

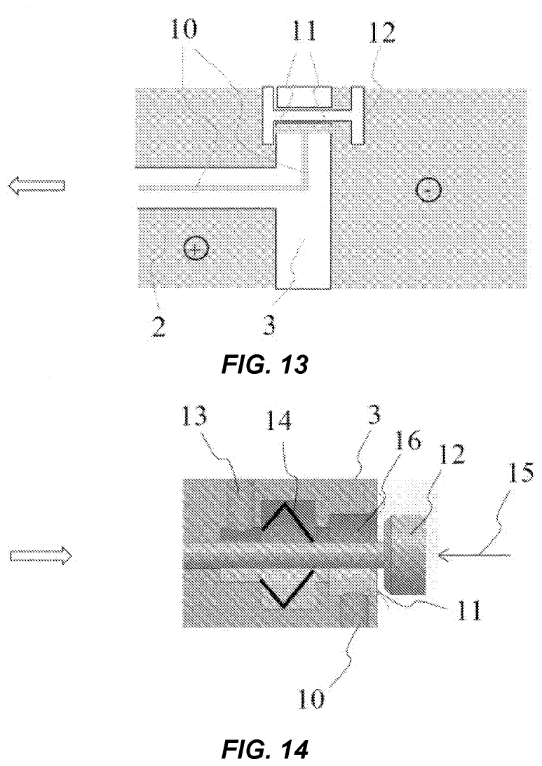

FIG. 13 shows a third embodiment of the Slider (12). In this case, the Slider (12) passes through the Piston (3) in a non-discontinuous cross section (for example, cylindrical). This embodiment results in insulation of the Slider (12) from transient forces between the Rod (2), the Piston (3) and the body (not shown in the figure), and in thus guaranteeing a translation of the device of optimized quality and responsiveness.

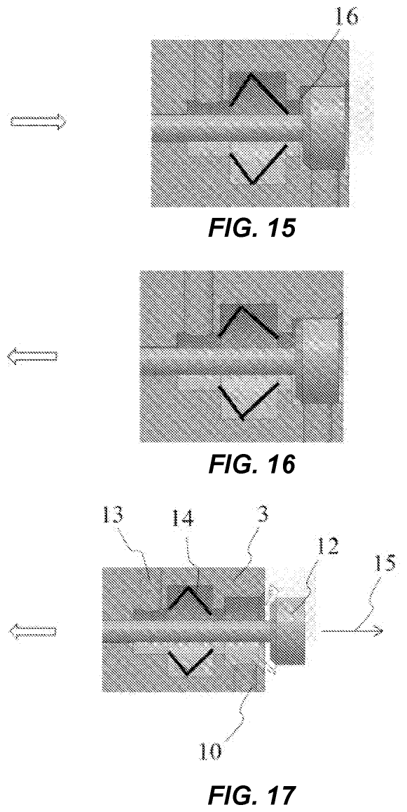

FIGS. 14-17 show a particular embodiment of this type of “continuous” Slider during the phases of start of compression (FIG. 14), compression (FIG. 15), start of expansion (FIG. 16), and expansion (FIG. 17). During the start of the expansion phase, the Slider (12) closes an oil volume (16) that reduces as the Slider approaches its end position (shutoff of the Compensation Orifices (11)). The arrow (15) shows the direction of movement of the Slider (12). The shape of the Slider is such that the volume (16) is closed before the “solid” interaction between the Slider (12) and the Piston (3). The confinement of this volume creates a hydraulic stop. The oil volume is connected to a Hydraulic Circuit (13) that is connected to the expansion Chamber and comprises a device of the non-return type (14) that makes it possible to re-supply the oil volume during the phase change, and to displace the Slider (12) again. The system operates for just one side of the piston. Since the Slider (12) is continuous, an equivalent system is present on the other side of the piston. A hydraulic circuit equivalent to the hydraulic circuit (13) is thus connected to the Compression Chamber. In this embodiment, the Slider (12) is formed by a rigid pin that passes through a bore formed in the Piston (3), different from the internal channel(s) (10) for the passage of fluid, the pin being provided at least end of an internal radial extension and an external radial extension, the extensions ensuring the function of the shutoff Valves. In this embodiment, the shutoff Valves thus form a single piece with the pin.

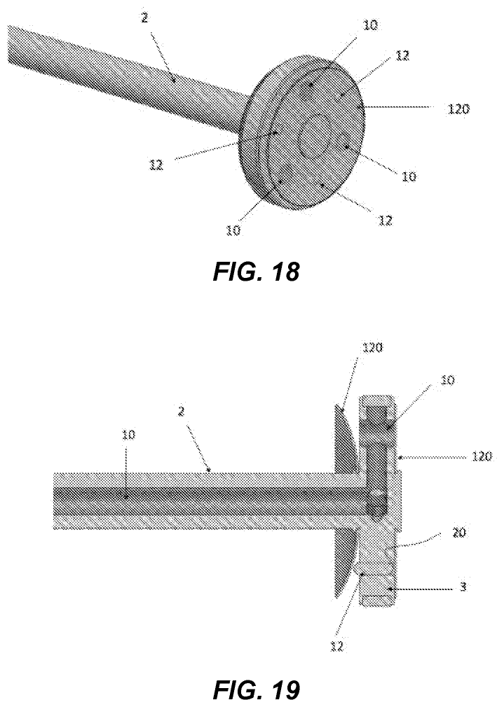

FIGS. 18-21 show a fourth embodiment. In this embodiment, the shutoff Valves are secured not to the Slider (12) but to the Piston (3). More particularly, the shutoff Valves comprise two flexible plates (120) fixed on either side of the Piston (3) and secured thereto. The Sliders (12) comprise pins mounted in the passages (20) passing through the Piston (3) and opening on either side of the Piston (3), in the expansion chamber (5) and in the compression chamber (4). In the embodiment shown (FIG. 18), the Piston (3) comprises three passages (20) that accommodate, respectively, a pin (12) and three internal channels (10) allowing for the passage of oil. The pins are of a length sufficient for ensuring the “detachment” of the plates (120) from the Piston (3).

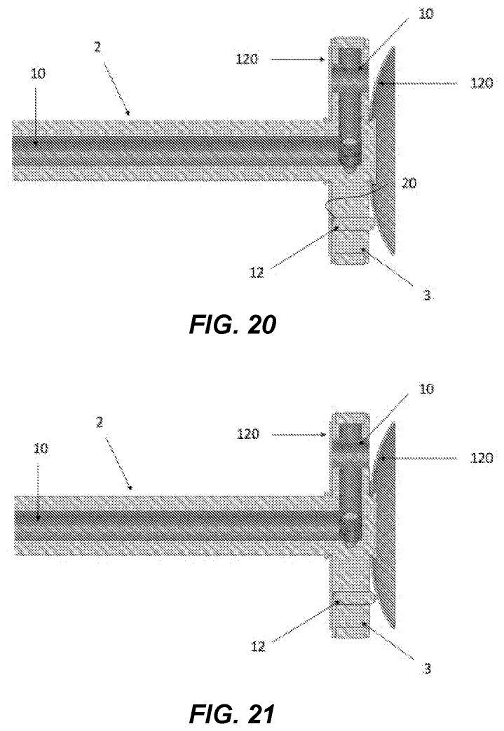

As shown in FIGS. 19 and 20, the plates are capable of moving from a shut-off position in which the plates are arranged so as to be placed against the piston so as to shut off the compensation Orifices (11) to an open position in which they are moved apart from the piston under the thrust action of the pins, thus freeing the compensation orifices (11) under the action of the pins.

Thus, FIG. 19 shows the “real” compression phase. The plate on the compression chamber (4) side is placed against the face of the Piston (3) with which it is associated, shutting off the compensation Orifices (11) that open into the Compression Chamber (4), while the plate on the expansion chamber (5) side is pushed back by the Sliders (12), thus opening the compensation Orifice (11) that opens into the expansion Chamber (5).

FIG. 20 shows the “real” expansion phase. The plate on the expansion chamber (5) side is placed against the face of the Piston (3) with which it is associated, shutting off the compensation Orifices (11) that open into the expansion Chamber (5), while the plate on the compression chamber (4) side is pushed back by the Sliders (12), thus opening the compensation Orifice (11) that opens into the compression Chamber (4).

By selecting the rigidity of the Valves and the length of the pins, it is possible to adjust the responsiveness of the system and its filtration range (filtered frequencies and amplitudes), i.e., the range over which the expansion Chambers (5) and the compression Chamber (4) are directly connected, and in order for the piston to be unable to transmit a force (no oil movement). FIG. 21 shows the position of the Valves in the filtration phase.

The present disclosure (and these various embodiments) is particularly suitable for the damper design used in the front or rear suspension systems of land vehicles, in particular, bicycles, motorbikes, cars, etc.

The present disclosure is described above by way of example. It will be understood that a person skilled in the art is able to implement different variants of the present disclosure.

### LIST OF REFERENCE SIGNS

(1) Main Body
(2) Rod
(3) Piston
(4) Compression Chamber
(5) Expansion Chamber
(6) Energy Dissipation Device
(7) Hydraulic Circuits
(8) Compensation Chamber
(9) Floating Piston
(10) Internal Channels
(11) Compensation Orifices
(12) Slider
(13) Hydraulic Circuits
(14) Non-return Device
(15) Direction of displacement of the Slider
(16) “confined” Oil Volume

1. A device for volume compensation of a damping liquid for a damper, comprising:
at least one hollow cylindrical Main Body containing a fluid and having at least one end provided with an axial passage for the passage, sealing and guiding of a Rod, the Rod being secured to a Main Piston moving in translation inside the Main Body and dividing an interior of the Main Body into two different working chambers, one constituting a Compression Chamber and the other constituting an Expansion Chamber, the Compression Chamber and the Expansion Chamber being directly connected to one another via one or more internal channels in the Piston for the passage of the fluid through the Piston and one or more compensation Orifices in the region of the Piston that open into the Compression Chamber and into the Expansion Chamber;
shutoff Valves for the Compensation Orifices that open into the Compression Chamber and into the Expansion Chamber; and
at least one rigid component which is interposed between the shutoff Valves opening into the Compression Chamber and into the Expansion Chamber, the rigid component being able to move in translation in the axial direction of the Rod and of the Main Body, between a first end position in which the Compensation Orifices that open into the Expansion Chamber are shut off by the dedicated valve(s), while the Compensation Orifices that open into the Compression Chamber are not shut off by the dedicated valve(s), and a second end position, referred to as the compression position, in which the Compensation Orifices that open into the Compression Chamber are shut off by the dedicated valve(s), while the Compensation Orifices that open into the expansion Chamber are not closed by the dedicated valve(s), the compensation Orifices and the rigid component being positioned such that it is impossible to simultaneously close both the compensation Orifices that open into the Compression Chamber and the compensation Orifices that open into the Expansion Chamber, and such that the sum of the cross sections of the compensation Orifices that are not shut off by the actuating rigid component allow for a direct passage of oil;
wherein the rigid component is arranged so as to move freely in translation through a Passage formed in the region of the Piston, which passage is different from the or said Internal Channels.

2. The device of claim 1, wherein the shutoff Valves comprise two flexible plates that are fixed on either side of the Piston and are secured thereto, the plates being capable of moving from a shut-off position in which the plates are arranged so as to be placed against the piston so as to shut off the compensation Orifices to an open position in which they are moved apart from the piston under a thrust action of the rigid component, thus freeing the compensation orifices.

3. The device of claim 1, wherein the rigid component comprises a pin moving in translation through a passage passing through the Piston.

4. The device of claim 3, wherein the shutoff valves are arranged at the end of the pin.

5. The device of claim 1, wherein the shutoff valves and the rigid component form a single piece.

6. The device of claim 1, wherein the passage through which the rigid component moves in translation is arranged between the piston and the piston body.

7. The device of claim 6, wherein the rigid component is in contact with the Main Body in the radial direction.

8. The device of claim 1, wherein the rigid component passes through the Piston in a discontinuous cross section.

9. The device of claim 6, wherein:
the rigid component closes an oil Volume on the compression side during a compression phase, and on the expansion side during an expansion phase, that reduces the approach of the rigid component toward its end position;
the shape of the rigid component being such that the Volume becomes closed before solid interaction of the rigid component with the Piston; and
the oil Volume being connected to the Expansion Chamber or the Compression Chamber via a Hydraulic Circuit that further comprises a device of the non-return type that allows for the movement of oil solely from the Expansion Chamber (or, respectively, Compression Chamber) toward the Volume.

10. The device of claim 1, wherein the rigid component and the Piston are of a complementary shape that allows for the closure of the orifices in a progressive manner, and wherein the Orifices are entirely shut off before any solid contact between the rigid component and the Piston.

11. The device of claim 1, further comprising a Compensation Chamber connected directly to the Compression Chamber and to the Expansion Chamber.

12. The device of claim 1, wherein the Compensation Chamber is connected to the Compression Chamber and to the Expansion Chamber via an inner axial channel of the Rod which is fluidically connected to the internal channel of the Piston.

13. The device of claim 12, wherein:
the Compensation Chamber is secured to the Rod;
the Compensation Chamber is located opposite the Piston; and
the Compensation Chamber is located outside of the main Body.

14. The device of claim 2, wherein the rigid component comprises a pin moving in translation through a passage passing through the Piston.

15. The device of claim 14, wherein the shutoff valves are arranged at the end of the pin.

16. The device of claim 15, wherein the shutoff valves and the rigid component form a single piece.

17. The device of claim 2, wherein the passage through which the rigid component moves in translation is arranged between the piston and the piston body.

18. The device of claim 17, wherein the rigid component is in contact with the Main Body in the radial direction.

19. The device of claim 3, wherein the rigid component passes through the Piston in a discontinuous cross section.

20. The device of claim 3, further comprising a Compensation Chamber connected directly to the Compression Chamber and to the Expansion Chamber.
